(19) United States
(12) Patent Application Publication
(10) Pub. No.: US 2010/0192379 A1
(43) Pub. Date: Aug. 5, 2010

(54) CUTTING DEVICE FOR A SPHERICAL FRUIT OR VEGETABLE HAVING A SKIN.

(75) Inventors: Patrick Lambertus Kerkhof, Zoetermeer (NL); Eelco Jan Gerardus Witteveen, Schiedam (NL); Arnoldus Willem Zweekhorst, Delfgauw (NL)

Correspondence Address: YOUNG & THOMPSON, 209 Madison Street, Suite 500, Alexandria, VA, 22314, US

(73) Assignee: VACU VIN INNOVATIONS LTD., Queensway, Gibraltar (GB)

(21) Appl. No.: 12/602,482

(22) PCT Filed: May 22, 2008
(86) PCT No.: PCT/NL08/50301

§ 371 Date: Apr. 6, 2010

(30) Foreign Application Priority Data
May 24, 2007 (NL) 2000660

(51) Int. Cl. A47J 17/04; B26B 9/02; B26B 3/00

(52) U.S. Cl. 30/123.5; 30/356; 99/590; 426/518

(57) ABSTRACT

Cutting device provided with a curved bottom surface having a predetermined radius of curvature, provided with a front part, a rear part and with at least one longitudinal edge, as well as a cutting blade which is arranged transversely on the bottom surface and which extends at a distance from the longitudinal edge, in a longitudinal direction from the front part to the rear part and is connected to the bottom surface, which front part of the bottom surface is narrower in a transverse direction than the rear part, with a cutting edge extending in the longitudinal direction from a front point of contact with the bottom surface to a top which is situated at a distance from the bottom surface, which distance is at least 50% of the radius of curvature, preferably at least 75% of the radius of curvature, most preferably is at least virtually as great as the radius of curvature, and with an angle between the cutting edge and the bottom surface in the front point of contact being between 65° and 40°.

The invention relates to a cutting device for cutting a spherical fruit or vegetable.

FR 1,255,669 discloses a knife for peeling oranges or grapefruits which is provided with a curved bottom surface, on the centre axis of which a triangular blade is provided for cutting through the skin. On the rear side, the bottom surface is provided with an annular handle which fits the palm of the hand of a user. By moving the curved bottom surface along the circumference of the citrus fruit, the triangular blade cuts through the skin, so that this can subsequently be removed in a simple manner.

The known cutting device has the drawback that is only suitable for cutting through the skin and cannot be used for separating the flesh of the fruit from the skin.

U.S. Pat. No. 4,255,854 discloses a grapefruit knife which is provided with a curved bottom surface with a bifurcated end provided with two parallel blades perpendicular to the bottom surface for cutting grapefruit segments from the skin. The drawback of this knife is that it cannot be used for cutting through and removing the skin, as a result of which a second knife is required in order to cut the citrus fruit in two.

It is an object of the invention to provide a multi-functional cutting device for spherical fruits or vegetables, such as citrus fruits, melons, spherical bell peppers or zucchini, pumpkins and the like, by means of which both the skin of the fruit or vegetable can be cut through easily and by means of which individual segments of fruit or vegetable can be detached from the skin. It is a further object of the invention to provide a cutting device which can be handled in a simple manner, without the user risking injuring himself. It is also an object to provide a cutting device which can be handled in a simple manner by both left-handed and right-handed users. Finally, it is an object to provide a cutting device by means of which regularly formed segments of flesh can be detached from the skin in a hygienic manner and be placed in a desired position of use. The cutting device should be easy to clean.

To this end, a cutting device according to the invention is provided with a curved bottom surface having a predetermined radius of curvature, provided with a front part, a rear part and with at least one longitudinal edge, as well as a cutting blade which is arranged transversely on the bottom surface and which extends at a distance from the longitudinal edge, in a longitudinal direction from the front part to the rear part and is connected to the bottom surface, which front part of the bottom surface is narrower in a transverse direction than the rear part, with a cutting edge extending in the longitudinal direction from a front point of contact with the bottom surface to a top which is situated at a distance from the bottom surface, which distance is at least 50% of the radius of curvature, preferably at least 75% of the radius of curvature, most preferably is at least virtually as great as the radius of curvature and with an angle between the cutting edge and the bottom surface in the front point of contact being between 65° and 40°, preferably approximately 55°.

Due to the fact that the cutting blade gradually rises from the front tip towards the rear over a relatively great height, the cutting edge cuts along the outside of the skin when the curved bottom surface is moved over the outside of the skin, beyond the skin into the flesh, so that, following a 360 degree rotation, the fruit or vegetable is cut in two.

With fruits or vegetables having a hollow core or having a core containing one or more stones or pips, the cutting blade only has to extend up to a distance from the bottom surface which corresponds to the thickness of the flesh in order to divide the fruit or vegetable into two halves. With vegetables or fruit where the flesh continues up to the core, it is advantageous if the greatest distance of the cutting edge from the bottom surface approximately corresponds to the radius of the fruit or vegetable in order to be able to divide this into two halves.

As the curvature of the bottom surface corresponds to the curvature of the fruit, and forms a wide support which prevents the cutting blade from tilting sideways, the cutting device can be moved along the skin of the fruit by the user in a continuous circular contour in a simple manner. In this case, the cutting blade, which gradually rises in the rear direction, cuts through the fruit in a stable and self-aligning manner without leaning over sideways and the start of the cut meets the end thereof so that two identical halves are formed in an accurate manner.

As a result of the stable and self-aligning action of the cutting device according to the invention, the user does not need to use great force, thus further reducing the risk of injuries. As the gradient of the cutting edge to the bottom surface is not greater than 60 degrees, a natural cutting motion of the cutting blade into the fruit is achieved when the bottom surface is rotated along the circumference.

After the fruit or vegetable has been divided into two halves, the tip of the cutting device can be used to scoop the pips or stones from the central part of the fruit. Subsequently, with each half of the cut fruit, the tip of the cutting device can be inserted between the skin and the flesh along the section edge of the fruit, and the bottom surface can be pushed downwards from the section edge. In this case, the tip of the cutting device moves to the top of the halved fruit and the cutting edge cuts through the flesh up to the core. By repeating this operation at neighboring positions along the section edge of the halved fruit, it is possible to obtain segments of cut flesh which are of a regular shape.

Due to the fact that the fruit is cut in half with the cutting device before the flesh is removed, the juice which is released in the process collects in the skin, which results in a very hygienic process. By means of the cutting device according to the invention, it is possible to remove the flesh from the skin in a hygienic manner without having to be touched by the user.

The cutting device may be formed in a relatively inexpensive manner from a single plastic part which can easily be cleaned. Due to the fact that all surfaces of the cutting device are gradually curved, in particular the bottom surface and the cutting blade, it is safe and user-friendly.

Preferably, the cutting blade is positioned in the centre of the bottom surface, which bottom surface comprises two longitudinal edges which extend on either side of the cutting blade. This results in a cutting device which has a T-shaped cross section and can be used both by left-handed and right-handed users. The cutting edges extend from a common point at the front part of the bottom surface to a widened rear part, with the distance between the side edges increasing. As a result thereof, the side edges have a strong cutting effect if the tip of the bottom surface is pushed between the skin and the flesh from the section edge downwards and this only requires little effort on the part of the user.

A cutting device according to the invention which is particularly suitable for spherical fruits or vegetables having a diameter of at least 10 cm, such as a melon or spherical zucchini has a bottom surface with a similar radius of curvature, such as for example approximately 13 cm.

The front tip may be at an angle to the bottom surface, so that the tip has a smaller radius of curvature compared to other parts of the bottom surface. This prevents the tip from piercing through the skin when the bottom surface is inserted between the skin and the flesh.

Preferably, the tip is of spoon-shaped design, so that the pips or stones can easily be scooped out of the central part of the fruit and so that flesh which has been cut loose can stay thereon in a stable manner and can be taken to the correct location without being touched by the hands of the user and be served, for example, on a plate directly from the skin.

In one embodiment of a cutting device according to the invention, the cutting edge is connected to a handle near the rear side by means of a gradual curvature. As a result, sharp corners on the cutting blade are avoided and the risk of injury of the user is reduced still further. Preferably, the cutting edge extends in an arc from the top to the handle.

The bottom surface may, along at least one longitudinal edge, be provided with a cutting edge. This facilitates insertion of the cutting device between the flesh and the skin. Preferably, the cutting edge of the cutting blade and/or the longitudinal edge are provided with teeth.

In order to gain additional lateral stability when inserting the cutting device between the skin and the flesh, the bottom surface may, on a side which is turned away from the cutting blade, be provided with a rib which extends in the longitudinal direction and which cuts from the section edge into the inside of the skin when it is inserted.

In order to prevent a vacuum from being created when a cutting device which is inserted between the skin and the flesh is removed, the bottom surface, on a side which is turned away from the cutting blade, may be provided with at least one venting slot which extends in the longitudinal direction. As a result thereof, a cutting device which is inserted between the skin and the flesh can easily be removed again.

In order to be able to apply sufficient force when inserting the cutting device, the rear side of the bottom surface is provided with a widened handle. Through an opening in the handle, the user can extend his fingers through the latter in order to have a better grip.

By way of example, some embodiments of a cutting device according to the invention will be explained below in more detail with reference to the attached drawing, in which:

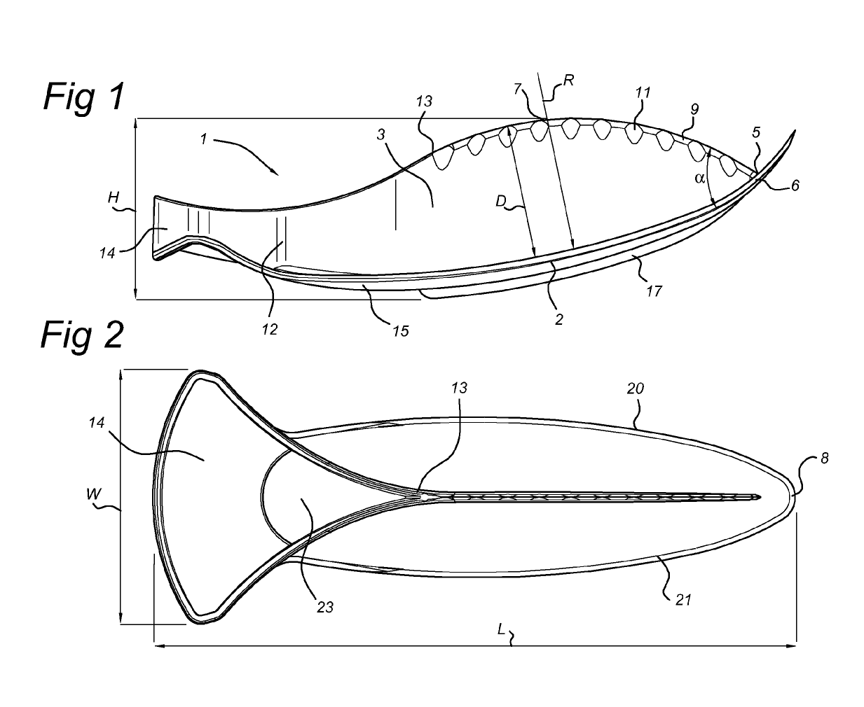

FIG. 1 shows a side view of a cutting device according to the invention,

FIG. 2 shows a top view of the cutting device from FIG. 1,

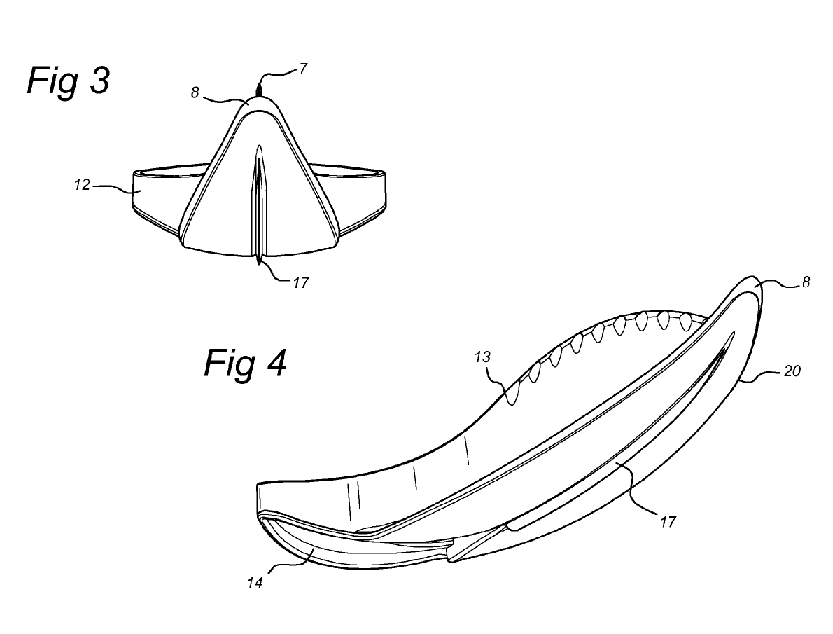

FIG. 3 shows a front view of the cutting device from FIGS. 1 and 2,

FIG. 4 shows a perspective bottom view of the cutting device from FIGS. 1 and 2,

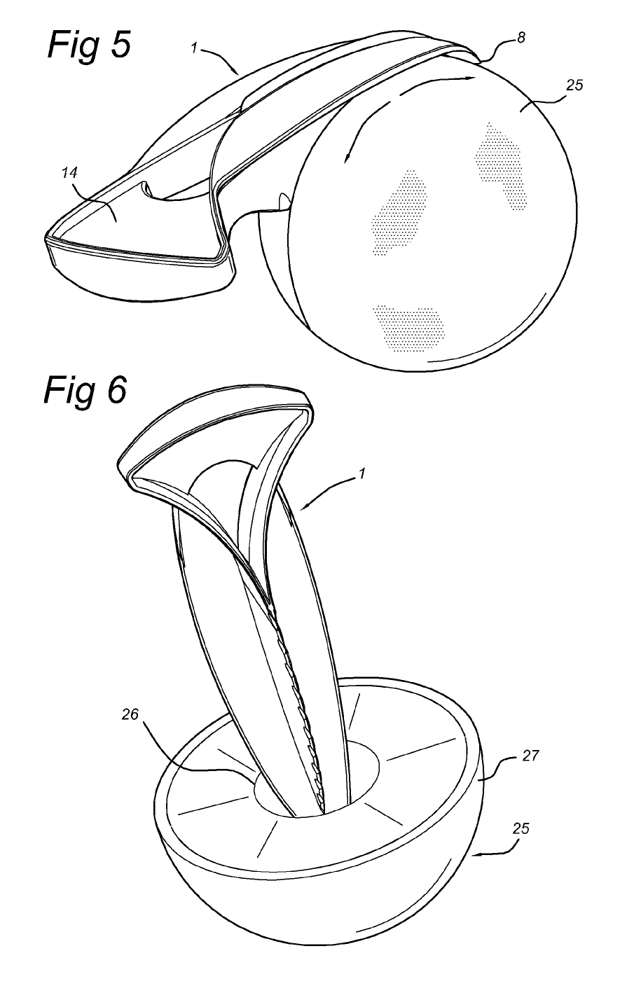

FIG. 5 shows how a melon is cut in half using the cutting device according to the invention,

FIG. 6 shows how the core of a cut fruit or vegetable is removed using the cutting device according to the invention,

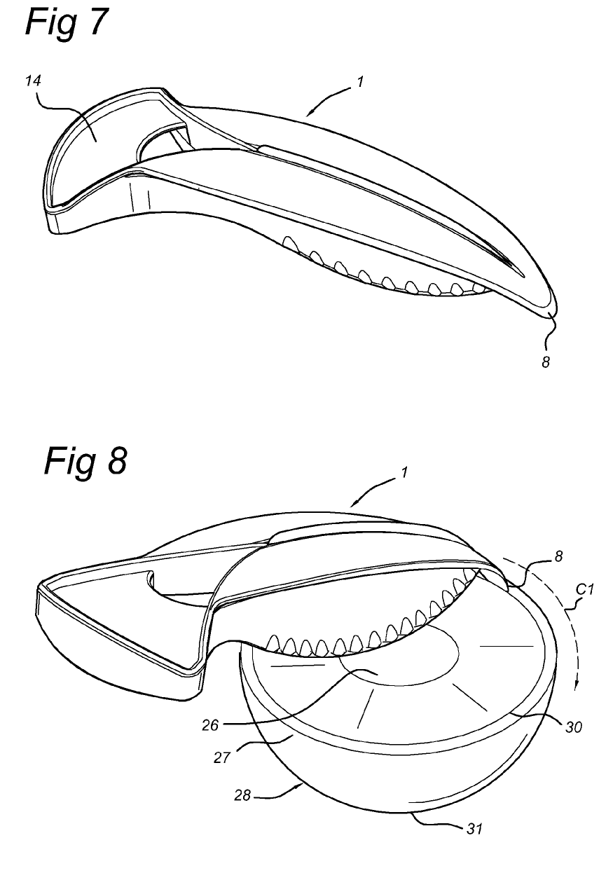

FIG. 7 shows a perspective bottom view of the cutting device

FIG. 8 shows how the flesh is removed from a melon half using the cutting device,

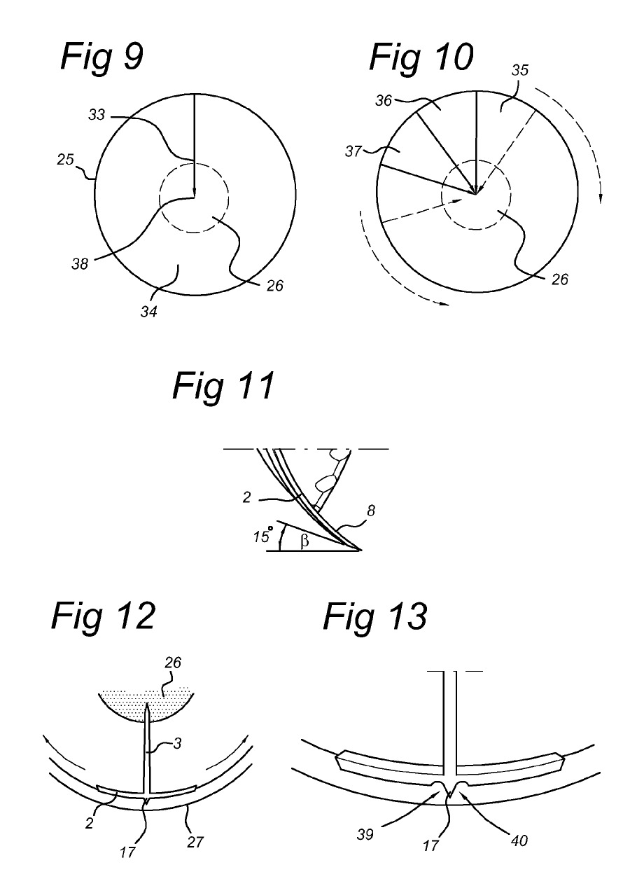

FIGS. 9 and 10 show a diagrammatic representation of the incisions made by the cutting blade when removing the flesh in segments,

FIG. 11 shows a side view on an enlarged scale of the tip of the cutting device,

FIG. 12 shows a cross section through a cutting device which has a stabilizing rib on the bottom side, and

FIG. 13 shows a cross section through a cutting device which is provided with two venting slots.

FIGS. 1 to 4 show a cutting device 1, provided with a curved bottom surface 2 and a cutting blade 3 positioned at right angles to the bottom surface. The bottom surface 2 has a radius of curvature R of 65 mm, which corresponds to an average diameter of a spherical fruit or vegetable, in this case a melon with a diameter of 13 cm. The cutting blade 3 extends from a front point of contact 5 with the front part 6 of the bottom surface in an arc to a top 7. The top 7 of the cutting blade 3 is at a distance D of approximately 4.5 cm from the bottom surface 2. The cutting edge 9 of the cutting blade 3 is at an angle α to the bottom surface of 55° and is provided with teeth 11.

The rear part 12 of the cutting device 1 forms a widened handle 14 having an opening 23. The cutting edge 9 extends along a convex curvature from the top 7 to an end point 13 and from there along a concave curvature to the handle 14 in the rear part 12, so that a rounded shape is produced on which the user cannot injure himself.

A stabilizing fin 17 is provided on a bottom side 15 of the bottom surface 2. The dimension H of the cutting device in the height direction is approximately 6 cm, while a dimension L in the longitudinal direction is 20 cm.

As can be seen in FIG. 2, the bottom surface 2 has two longitudinal edges 20, 21, which meet at the front tip 8 and diverge in the rear direction, thus producing a wedge shape. Each longitudinal edge 20, 21 is sharpened to form a cutting edge.

FIG. 5 shows the cutting device 1 during the process of cutting a melon 25 in half. In this case, the user grasps the cutting device 1 at the handle 14 and pushes the cutting blade 3 through the skin 27 of the melon 25 until the bottom surface 2 rests against the outer circumference of the melon. Subsequently, the bottom surface is moved in a circular contour along the outer circumference of the melon, during which the outer side of the melon 25 rests on the curved bottom surface 2, so that the cutting blade is held in a perpendicular position and does not assume an oblique position during cutting. As a result of the curved bottom curved bottom surface being guided with respect to the correspondingly curved outer surface of the melon, an accurately continuous closed contour can be achieved.

When the melon 25 is being cut in half, the top 7 of the cutting blade does not extend as far as the centre of the melon, but only to the central region 26 containing the seeds. The teeth 11 along the cutting edge 9 ensure that the skin of the melon is cut in an effective manner.

As illustrated in FIG. 6, the seeds are subsequently removed from the central region 26 using the spoon-shaped tip 8 of the cutting device 1. In this case, the small width of the tip of, for example, 35 mm has the advantage that the amount of flesh which is removed from the central region 26 is limited.

As is illustrated in FIG. 8, tip 8 of the cutting device is then pushed along the section edge 30 of the melon half 28, along the inside of the skin 27 in a downward direction to the top 31 of the melon half 28. In this case, the cutting blade 3 makes an incision 33 in the flesh 34 of the melon half 28, as is illustrated in FIG. 9, which extends from the inside of the skin 27 to the central region 26 of the melon half 28. The longitudinal edges 20, 21 cut through the flesh, so that this comes off the skin across a width of half a flesh segment 35, 36. By repeating this cutting movement, segments 35, 36, 37 of detached flesh are formed, as can be seen from FIG. 10, which can be scooped from the skin 25 by means of the spoon-shaped tip 8.

As can be seen in FIG. 11, the tip 8 is at an angle with respect to the bottom surface 2, and the tip is at an angle β of 15° with respect to the horizontal, in order to prevent the tip 8 from penetrating the skin when it is inserted along the inside of the skin 27.

FIG. 12 shows the T-shaped cross section of the cutting device 1 which is provided, on the bottom side, with the stabilizing fin 17 which cuts the inside of the skin 27 and in this manner keeps the bottom surface in the correct vertically aligned position when the cutting device is inserted between the skin and the flesh. As can be seen in FIG. 13, the bottom surface 2 is provided with a venting slot 39, 40 having a depth of, for example, 1.5 mm, on either side of the stabilizing fin 17.

Although the cutting device may have an L-shaped cross section, a T-shaped cross section is preferred as this can be positioned in an unambiguous way and can be used by both right-handed and left-handed users.

Although the use of the cutting device according to the invention has been described with reference to a melon, it can also be used for a plurality of spherical (also including irregular shapes, such as lemons, tomatoes, bell peppers or avocados) fruits and vegetables, such as also oranges, grapefruits, pumpkins, etc.

1. A cutting device (1) provided with a curved bottom surface (2) having a predetermined radius of curvature (R), provided with a front part (6), a rear part (12) and with at least one longitudinal edge (20, 21), as well as a cutting blade (3) which is arranged transversely on the bottom surface and which extends at a distance from the longitudinal edge, in a longitudinal direction from the front part (6) to the rear part (12) and is connected to the bottom surface, which front part (6) of the bottom surface (2) is narrower in a transverse direction than the rear part (12), with a cutting edge (9) extending in the longitudinal direction from a front point of contact (5) with the bottom surface (2) to a top (7) which is situated at a distance (D) from the bottom surface, which distance (D) is at least 50% of the radius of curvature (R), preferably at least 75% of the radius of curvature, most preferably is at least virtually as great as the radius of curvature, and with an angle (α) between the cutting edge (9) and the bottom surface (2) in the front point of contact (5) being between 65° and 40°.

2. The cutting device as claimed in claim 1, in which the radius of curvature (R) of the bottom surface is between 5 cm and 15 cm.

3. The cutting device as claimed in claim 1, in which the bottom surface (2) comprises two longitudinal edges (20, 21) which extend on either side of the cutting blade (3) and which meet in a tip (8) of the front part (6) of the bottom surface (2), in which a distance between the longitudinal edges (20, 21) increases from the tip (8) in the direction of the rear part (12) of the bottom surface (2).

4. The cutting device as claimed in claim 1, characterized in that the bottom surface (2) is provided with a cutting edge along at least one longitudinal edge (20, 21).

5. The cutting device as claimed in claim 3, in which the tip (8) is at a distance from the point of contact (5) of the cutting blade (9) with the bottom surface (9) and is at an angle to the bottom surface.

6. The cutting device as claimed in claim 5, in which the tip (8) is spoon-shaped.

7. The cutting device as claimed in claim 1, in which the cutting edge (9) extends in an arc from the top to the rear part (12).

8. The cutting device as claimed in claim 1, in which the cutting edge of the cutting blade (3) and/or the longitudinal edge (20, 21) are provided with teeth (11).

9. The cutting device as claimed in claim 1, in which the bottom surface (2), on a side which is turned away from the cutting blade, is provided with a rib (17) which extends in the longitudinal direction.

10. The cutting device as claimed in claim 1, in which the bottom surface (12), on a side which is turned away from the cutting blade, is provided with at least one venting slot (39, 40) which extends in the longitudinal direction.

11. The cutting device as claimed in claim 1, characterized in that the cutting edge (9) is connected to a handle (14) near the rear part (12) of the cutting device.

12. The cutting device as claimed in claim 11, in which a widened handle (14) is integrally formed with the bottom surface (2) in the rear part (12).

13. The cutting device as claimed in claim 12, in which the widened handle (14) has an opening (23).

14. A method for removing flesh from a spherical fruit or vegetable (25) having a skin (27) using a cutting device (1) as claimed in claim 1, comprising the following steps:
pushing the cutting blade (3) along the circumference of the fruit or vegetable, with the bottom surface (2) lying against the skin (27) and the cutting blade (9) penetrating into the fruit or vegetable,
cutting the fruit or vegetable into two halves,
inserting the bottom surface (2) by the tip (8) along a section edge (30) of one half of the fruit or vegetable between the skin (27) and flesh, and moving the bottom surface (2) to the top (31) of the halved fruit or vegetable,
repeating the above step at least once at a neighboring position along the section edge (30) of the halved fruit or vegetable, so that a segment (35, 36, 37) is formed which is detached from the skin and other flesh.

15. The method as claimed in claim 14, in which the detached flesh resting on the tip (8) is detached from the half skin and is moved on in a position of use of the bottom surface.

16. The cutting device as claimed in claim 2, in which the bottom surface (2) comprises two longitudinal edges (20, 21) which extend on either side of the cutting blade (3) and which meet in a tip (8) of the front part (6) of the bottom surface (2), in which a distance between the longitudinal edges (20, 21) increases from the tip (8) in the direction of the rear part (12) of the bottom surface (2).

17. The cutting device as claimed in claim 2, characterized in that the bottom surface (2) is provided with a cutting edge along at least one longitudinal edge (20, 21).

18. The cutting device as claimed in claim 3, characterized in that the bottom surface (2) is provided with a cutting edge along at least one longitudinal edge (20, 21).

19. The cutting device as claimed in claim 16, in which the tip (8) is at a distance from the point of contact (5) of the cutting blade (9) with the bottom surface (9) and is at an angle to the bottom surface.
